(19) United States
(12) Patent Application Publication
(10) Pub. No.: US 2015/0305355 A1
(43) Pub. Date: Oct. 29, 2015

(54) SYSTEMS AND METHODS FOR FOOD PREPARATION AND PRESERVATION

(71) Applicant: David Clint Blythe, Austin, TX (US)

(72) Inventor: David Clint Blythe, Austin, TX (US)

(21) Appl. No.: 14/692,826

(22) Filed: Apr. 22, 2015

Related U.S. Application Data
(60) Provisional application No. 61/983,975, filed on Apr. 24, 2014.

(51) Int. Cl. A23B 4/10; A23L 3/015

(52) U.S. Cl. CPC A23B 4/10; A23L 3/015; A23V 2002/00

(57) ABSTRACT

Embodiments disclosed herein describe systems and methods for coating unprepared food with melanin to insulate the food product while cooking the food product.

### CROSS-REFERENCE TO RELATED APPLICATIONS

This application claims a benefit of priority under 35 U.S.C. §119 to Provisional Application No. 61/983,975 filed on Apr. 24, 2014, which is fully incorporated herein by reference in its entirety.

### BACKGROUND INFORMATION

1. Field of the Disclosure

Examples of the present disclosure are related to systems and methods for food preparation and preservation. More particularly, embodiments relate to coating unprepared food with melanin to seal and insulate the food.

2. Background

Melanin, which is a broad term for a group of natural pigments found in most organisms, is produced by a specialized group of cells known as melanocytes. There are three basic types of melanin: eumelanin which is produced in black and brown subtypes, pheomelanin which includes red-brown polymers, and neruormelanin.

Melanin may be found in a number of different forms ranging from powder to liquid. One form of liquid melanin is found in squid ink. Squid ink may be comprised mainly of melanin but may also include proteins, lipids, minerals, amino acids, and other nutrients. Squid ink has many health benefits due to its nutrient density. As a result, squid ink is being added to food after preparation. However, squid ink can be utilized before food is prepared for various reasons.

Accordingly, needs exist for more effective and efficient systems and methods for coating unprepared food with melanin to insulate the food from indirect and direct energy radiation such as while the food is cooked and to seal the food from surrounding atmosphere and subsequent oxidizing components of the atmosphere.

### SUMMARY

Embodiments disclosed herein describe systems and methods for coating unprepared food with melanin to insulate the food product while being cooked.

In embodiments, a melanin marinade may be prepared, wherein the melanin marinade may be comprised of different forms including a powdered melanin, a liquid melanin, etc. Furthermore, the melanin marinade may include other additives, such as nutrients found in squid ink.

In embodiments, the melanin marinade may be disposed or coated over the food product to cover the entire surface of the food product before the food product is cooked, heated, prepared, etc. The amount of melanin marinade disposed over the surface of the food product may be based on the surface area of the food product, wherein an increase in surface area of the food product may require an increase in volume the melanin marinade.

In embodiments, the amount of melanin marinade coated over the food product may be applied until the surface of the food product is saturated with melanin marinade, wherein no more melanin marinade may adhere to the surface of the food product. Additionally, the melanin marinade may be positioned over the food product such that the entire surface of the food is covered with melanin marinade, wherein the melanin marinade may form a shell that is substantially the same size as the outer surface of the food product. In embodiments, the melanin marinade may be positioned over the food product the form a thin, uniform seal.

In embodiments, after covering the entire surface area of the food product with the melanin marinade, the food product may be heated, cooked, prepared, etc. In embodiments, the amount of time and/or temperature required to heat, cook, prepare, etc. the food product may be based on the type of food product, the size of the product, and/or other factors. For example, if the food product is 4 oz. of red meat, then the food product may be cooked for a first period of time at a first temperature, and if the food product is 4 oz. fish, then the food product may be cooked for a second period of time at a second temperature. In further embodiments, approximately one teaspoon (˜4 g) of melanin marinade may be utilized for one pound of food product, however usage may vary based on type of food product.

In embodiments, when cooking the food product coated with the melanin marinade, the heated melanin marinade may form a semi-rigid, semi-permeable cover that is configured to shield, insulate, and/or isolate the food product from indirect and direct heat or energy. Responsive to the melanin marinade shielding the food product while being cooked, the melanin marinade may create a sealing effect by helping to retain internal moisture of the pre-cooked food product. In embodiments, the food product may be cooked based on thickness, size, meat temperature, and/or type of meat. For example, a beef steak may be grilled or roasted at three hundred-twenty five degrees Fahrenheit for twenty five to thirty minutes for steaks that are one inch thick, and for forty to forty five minutes for steaks that are two inches thick. While cooking the food product, the internal cooking temperature of the food product may be approximately one hundred twenty eight degrees Fahrenheit

The energy protecting melanin may protect food from heating and slow the rise of internal temperature while cooking and may cause the pressure to increase within the food product and may speed the cooking process. While cooking the food product, the heat may not directly interface with the food product because of the melanin marinade, while the resulting pressure increase caused by the sealing effect may cause the food product to be cooked more efficiently, evenly, and faster, wherein the food product may not be damaged by not directly contacting a heat source and may aid in protein hydrolysis.

Additionally, the sealing effect may allow the food product to retain moisture and internal heat more efficiently and/or longer than food products that are not coated with a melanin marinade. Furthermore, by coating a surface of the food product with the melanin marinade, the food product may be able to retain moisture within the food product and protect from oxidizing atmospheric components so that leftovers do not spoil as quickly.

Additionally, the sealing effect may be configured to preserve the food product. When the heated melanin marinade may form a semi rigid, semi-permeable cover that shields the food product, the resulting shield may protect the food product from preventing the growth of bacteria, fungi, or other micro-organisms, as well as retarding the oxidation of the food product. Accordingly, the resultant permeable cover protecting the food product may allow the food product to maintain its weight and/or volume over extended periods of time. Furthermore, the permeable cover may prolong shelf life of the food product.

In further embodiments, based on the type of melanin marinade applied to the surface of the food product before preparation, the surface of the food product may be presented in different colors. For example, if a first type of melanin marinade is applied to the surface of the food product, the surface of the food product may appear to be blackened, whereas if a second type of melanin marinade is applied to the surface of the food product, the surface of the food product may have a reddish hue.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 depicts a melanin marinade covering a food product, according to an embodiment.

FIG. 2 depicts a melanin marinade covering a food product, according to an embodiment.

FIG. 3 depicts a cross section view of a melanin marinade covering a food product, according to an embodiment.

FIG. 4 depicts a method for applying melanin marinade over a food product, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Embodiments disclosed herein describe systems and methods for coating unprepared food with melanin to insulate the food product being cooked.

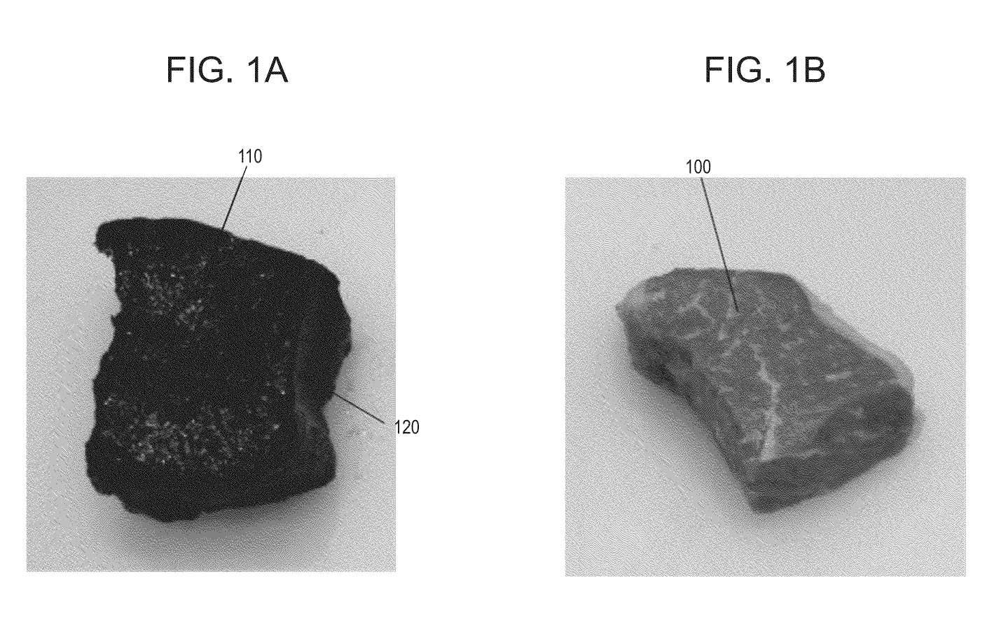

FIG. 1 depicts one embodiment of a food product 100 before any preparation, and a food product 110 being covered with a melanin marinade 120.

Food product 100 may be any type of food product ranging from meats (steak, fish, pork, etc.), fruit (apples, peaches, nuts, etc.), vegetables (carrots, potatoes, cauliflower, etc.), or any other type of food that can be cooked, heated, etc. In embodiments, different types of food products 100 may have different shapes and/or sizes. Furthermore, the different food products 100 may have different amounts of time they should be cooked and/or different temperatures that they should be cooked at, wherein the length of time and/or temperature that food product 100 should be cooked may be based on the size and/or type of food product 100.

Food product 110 may be food product 100 that is covered with melanin marinade 120. In embodiments, an entire surface area of food product 110 may be covered with melanin marinade 120.

Melanin marinade 120 may be comprised of different forms of organic, naturally found materials, such as melanin, wherein melanin marinade 120 may include a powdered melanin, a liquid melanin, etc. Furthermore, melanin marinade 120 may include other various additives. Melanin marinade 120 may be comprised of a 1:2 ratio of liquid to melanin base. Naturally derived Melanin concentrations may vary based on the melanin source and melanin extraction methods. The concentration of melanin in melanin marinade 120 may vary based on the ratio of liquid and spices to the melanin base. For example, melanin marinade 120 may include red melanin derived from red rice, black melanin derived from black sesame seeds, brown melanin derived from chestnuts, sepia, pale/light brown melanin from yellow sesame seeds, etc.

In embodiments, the melanin within the melanin marinade 120 may be configured to bond to food surfaces. The melanin marinade 120 may bond with the food surface until the food surface is fully saturated with melanin marinade 120, and no more melanin marinade 120 may adhere to the food surface. Responsive to covering food product 100 with the melanin marinade 120, the melanin marinade 120 may form an outer layer of food product 100. Hence, in embodiments, varying concentrations of melanin bases may be used successfully as long as there is sufficient quantity melanin marinade 120 to bond to the entire food surface. Therefore, a melanin marinade 120 with lower concentrations of melanin may require more melanin marinade 120 to be disposed on the surface of a food product to ensure adequate melanin marinade 120 covers the surface of the food.

In applying melanin marinade 120 to cover the surface area of food product 100 to form food product 110, the amount of melanin marinade 120 utilized to coat the surface of food product 100 may be based on a plurality of factors, such as the type of food product 100, size of food product 100, surface area of food product 100, and/or type of melanin marinade 120. In one embodiment, one teaspoon (˜4 g) of melanin marinade may be utilized to cover one sixteen ounce steak. In embodiments, melanin marinade 120 may be applied to a surface of food product 100 until the coloring of food product 100 does not change with more melanin marinade 120 being applied to the surface of food product 100.

Melanin marinade 120 may be applied to the surface of food product 100 before cooking food product 100 in a plurality of different ways, such as placing food product and melanin marinade 120 within a sealed bag, placing food product 100 and melanin marinade 120 within a food tumbler, etc.

Once melanin marinade 120 is applied to the entire surface area of food product 100 to form food product 110, the coating of melanin marinade 120 may become a rigid structure that is shaped to the original size of the food product 100 The coating of melanin marinade 120 may help retain the original shape and/or size or substantially the same shape and/or size of food product 100 while being cooked.

Responsive to food product 110 being heated, cooked, etc., food product 110 may desire to expand. However, because the coating of melanin marinade 120 is a semi-rigid structure, melanin marinade 120 may remain substantially the same size. Accordingly, food product 110 may attempt to expand while encased by the semi-permeable melanin marinade while heating due to a chemical reaction associated with contained water molecules within food product 110 as cooking occurs.

Because the coating of melanin marinade 120 may help retain the shape and/or size of the pre-cooked food product 100, a sealing effect within the coating of melanin marinade 120 may be created. The sealing effect may cause the pressure within the coating of melanin 120 covering food product 110 to increase, which may help retain internal moisture levels and protein hydrolysis.

While cooking food product 110, the heat may not directly interface with food product 110 because of the coating of melanin marinade 120. Therefore, the pressure resulting from the sealing effect may cause food product 110 to be cooked more efficiently, evenly, and faster. The sealing effect may also allow food product 110 to retain moisture more efficiently and/or longer than food products that are not coated with melanin marinade 120. The sealing effect may also allow food product 110 to have increased tenderness than food products that are not coated with melanin marinade 120.

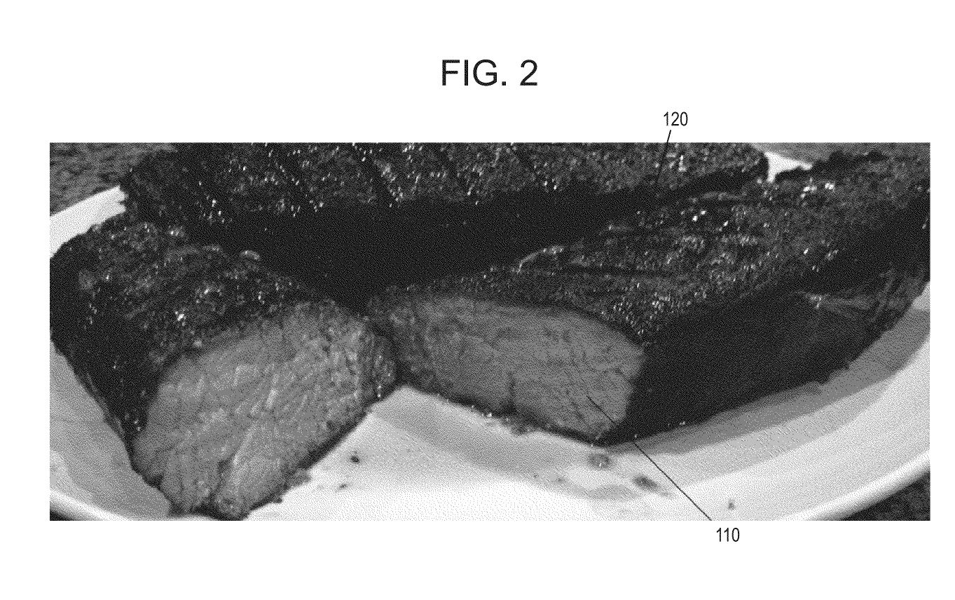

FIG. 2 depicts one embodiment of food product 110 coated within melanin marinade 120 after food product 110 has been cooked. As depicted in FIG. 2, the entire surface of food product 110 is coated with melanin marinade 120, wherein melanin marinade 120 may be bonded to the surface of food product 110. As such, the coating of melanin marinade 120 may form a rigid coating on food product 110 that does not allow food product 110 to expand while being cooked.

By coating food product 110 with melanin marinade 120, food product 110 may not lose moisture while being heating, and the semi-rigid coating of melanin marinade 120 may cause a sealing effect allowing food product 110 to be pressure cooked. The sealing effect may increase the pressure within the coating of melanin marinade 120 by increasing the temperature within the coating without expanding or minimally expanding the volume of space within the coating of melanin marinade 120. Furthermore, food product 110 may be cooked evenly via the sealed effect caused by the rigid coating of melanin marinade 120. However, if the internal pressure caused by the sealing effect is too great, the internal pressure may cause the semi-rigid coating of melanin marinade 120 to break. Furthermore, food product 110 may be cooked evenly via the sealed effect caused by the rigid coating of melanin marinade 120. Accordingly, once the internal pressure within the semi-rigid coating of melanin marinade 120 is above a pressure threshold, the semi-rigid coating may have at least one pore allowing the pressure caused by the sealing effect the decrease. In embodiments, the pressure threshold may be based on the amount of melanin marinade 120 disposed on food product 110, the concentration of melanin within melanin marinade 120, and/or the shape and size of food product 110.

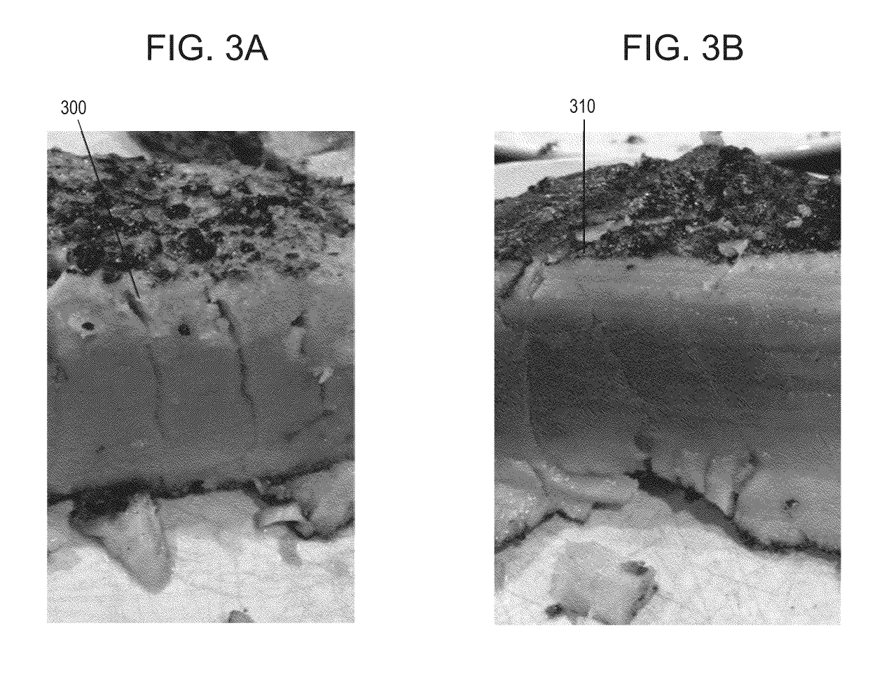

FIG. 3 depicts one embodiment of a food product 300 that was not coated with melanin marinade 120 before being cooked and a food product 310 that was covered with melanin marinade 120 before being cooked. As depicted in FIG. 3, melanin marinade 120 may change the surface texture and color of food product 310 after being cooked.

In embodiments, the coloring of the surface of food product 310 may be based on the type of melanin marinade 120 coating food product 310. Furthermore, FIG. 3 depicts the sealing effect that the coating of melanin marinade 120 has on food product 310, wherein food product 310 retains more moisture than food product 300 and food product 310 is cooked more evenly than food product 300.

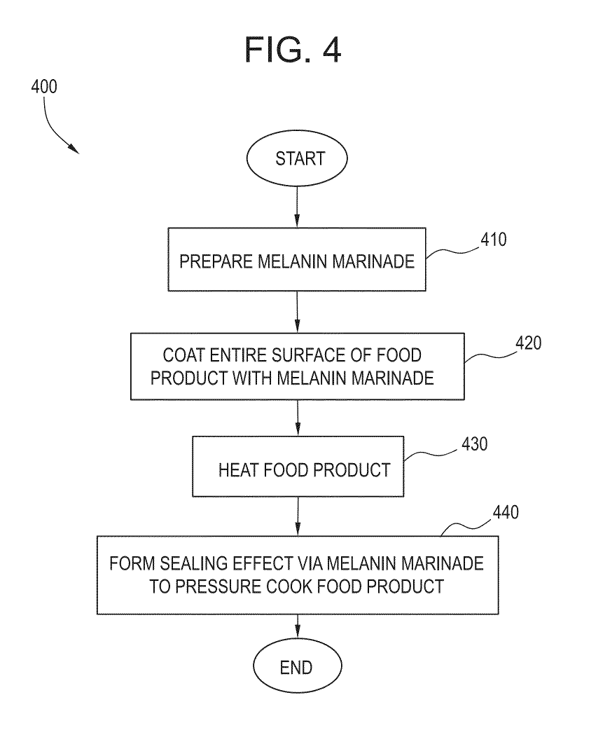

FIG. 4 depicts a method 400 for preparing a food product with a coating of a melanin marinade, according to an embodiment. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

At operation 410, a melanin marinade may be prepared. The melanin marinade may be prepared utilizing any known form of melanin, such as melanin found in squid ink, powdered melanin, etc. The melanin marinade may be prepared based on a desired coloring of the surface of a food product after the food product is cooked.

At operation 420, an entire surface of the food product may be coated with the melanin marinade. The amount of melanin marinade desired to coat the entire surface of the food product may vary based on the type of the food product, size of the food product, and/or the type of melanin marinade used. In embodiments, the entire surface of the food product should be covered with the melanin marinade to form a rigid structure conforming to the surface of the food product, such that the food product moisture cannot escape while being cooked. If the entire surface of the food product is not covered with the melanin marinade, then the food product may expand and lose moisture while being cooked where the food product is not covered with the melanin marinade.

At operation 430, the food product with the coating of the melanin marinade may be heated. Responsive to the food product being heated, the melanin marinade may form the semi-rigid structure encompassing the food product.

At operation 440, the melanin marinade coating the food product may cause a sealing effect that allows the food product to be pressured cooked. The sealing effect may cause the pressure to increase within the coating of melanin covering food product, which may speed the cooking process. Although while cooking food product the heat may not directly interface with food product because of the coating of melanin marinade, the pressure caused by sealing effect may cause food product to be cooked more efficiently, evenly, and faster.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

What is claimed is:

1. A method for preparing a food product:
preparing an organic marinade comprised of at least one form of melanin;
coating the food product with the organic marinade;
heating the food product with the organic marinade;
creating, via the organic marinade, a semi-rigid semi-permeable cover on the food product responsive to heating the food product, wherein the semi-rigid cover is substantially a same shape as the food product; and
increasing a pressure level within the semi-rigid cover responsive to heating the food product.

2. The method of claim 1, wherein the organic marinade is chemically bonded to the food product responsive to heating the food product.

3. The method of claim 1, wherein semi-rigid cover allows the food product to be pressure cooked within the semi-rigid cover.

4. The method of claim 1, wherein the semi-rigid cover does not become porous when the pressure within the semi-rigid cover is less than a pressure threshold.

5. The method of claim 1, wherein the organic marinade is coated over the entirety of the food product.

6. The method of claim 1, wherein the food product within the semi-rigid cover cannot expand to a size greater than the semi-rigid cover.
